(19) United States
(12) Patent Application Publication
(10) Pub. No.: US 2026/0261544 A1
(43) Pub. Date: Sep. 3, 2026

(54) WILDCARD FQDN BASED PRIVATE APPLICATION SECURITY POLICY FOR DAY ZERO ENFORCEMENT

(71) Applicant: Palo Alto Networks, Inc., Santa Clara, CA (US)

(72) Inventors: Jayant Jain, Cupertino, CA (US); Mingfei Peng, Pleasanton, CA (US); Ketan Kulkarni, San Jose, CA (US); Anal Srivastava, Fremont, CA (US); Brian Russell Kean, Cincinnati, OH (US); Brian David Levin, San Francisco, CA (US); Uttam Ramesh, Sunnyvale, CA (US)

(21) Appl. No.: 19/066,571

(22) Filed: Feb. 28, 2025

(51) Int. Cl. H04L 9/40

(52) U.S. Cl. CPC H04L 63/0236; H04L 63/20

(57) ABSTRACT

The present application discloses a method, system, and computer system for causing network traffic handling policies to be enforced with respect to a network traffic sample. An example of the method includes (i) configuring a wildcard application group with a wildcard Fully Qualified Domain Name (FQDN) for a set of one or more applications, and (ii) allocating an internet protocol (IP) address from an address pool to an application matching the wildcard FQDN. Another example of the method includes (a) configuring a wildcard application group with a wildcard FQDN for a set of one or more applications, (b) allocating an IP address from an IP address pool to a particular application matching the wildcard FQDN, (c) associating the allocated IP address with the wildcard application group; and (d) providing an indication that the allocated IP address is associated with the wildcard application group.

### BACKGROUND OF THE INVENTION

The growing complexity and scale of modern network infrastructures have created significant challenges in managing network traffic policies, particularly as organizations increasingly rely on dynamic, cloud-based applications and services. Traditional methods of applying network traffic policies, such as security protocols, are often static and do not effectively address the dynamic nature of networked applications. Specifically, as new applications are introduced or existing applications are modified, it becomes increasingly difficult to maintain accurate mappings between traffic and the appropriate security or access policies. This challenge is exacerbated in environments where applications are grouped together in broad categories, such as wildcard application groups, making it even more challenging to apply policies in a flexible and automated manner.

### BRIEF DESCRIPTION OF THE DRAWINGS

Various embodiments of the invention are disclosed in the following detailed description and the accompanying drawings.

FIG. 1 is a block diagram of an environment for providing a security service to a network according to various embodiments.

FIG. 2 is a block diagram of a system for causing network traffic handling policies to be enforced with respect to a network traffic sample according to various embodiments.

FIG. 3 is a flow diagram of a method for allocating an internet protocol (IP) address from an address pool for an application group according to various embodiments.

FIG. 4 is a flow diagram of a method for allocating an internet protocol (IP) address from an address pool for an application group according to various embodiments.

FIG. 5 is a flow diagram of a method for handling network traffic sample for an application within a particular application group according to various embodiments.

FIG. 6 is a flow diagram of a method for allocating an IP address to a discovered application according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security entity may be implemented as an application running on a device, such as an anti-malware application.

As used herein, a network traffic policy may include a set of rules or guidelines that govern how network traffic is handled, for example, within an organization's network infrastructure. These policies can define the conditions under which certain types of network traffic are allowed, blocked, or prioritized. Network traffic policies are important for ensuring the efficient and secure operation of a network, as they help prevent unauthorized access, protect sensitive data, and optimize the performance of network resources. Policies can be enforced at various levels of the network, including the firewall, routers, switches, and application gateways, and they can be applied based on factors like traffic type, destination, user, time of day, or the identity of the application generating the traffic.

As used herein, a security policy is a set of rules, procedures, and guidelines designed to protect an organization's digital assets, systems, and data from unauthorized access, misuse, or damage. It outlines how sensitive information should be handled, who is allowed to access it, and the measures in place to prevent threats, such as hacking, malware, or data breaches. A security policy can cover various aspects of network security, including access control, encryption, authentication, incident response, and monitoring, with the goal of ensuring the confidentiality, integrity, and availability of the organization's information and resources. By establishing clear protocols, security policies help mitigate risks and ensure that employees, systems, and applications adhere to best practices for safeguarding critical data.

Current systems for identifying application traffic and enforcing policies typically rely on static or predefined methods for classifying and routing network traffic. Traditional network security solutions, such as firewalls or intrusion detection systems, often use static rules based on IP addresses, ports, or predefined application signatures to identify and manage traffic. These systems can enforce policies by inspecting packets and matching them against predefined rules, which can include security measures like blocking suspicious traffic or restricting access to certain services. However, these approaches are limited in their ability to handle the dynamic nature of modern networks, where applications and services can frequently change or be deployed in different configurations, often without prior notice or manual updates to the system.

In some advanced systems, application identification is performed using deep packet inspection (DPI), where the contents of network traffic are examined to detect application protocols or behaviors. DPI can enable more granular control over network traffic by identifying traffic based on specific application signatures, such as HTTP, FTP, or custom application-level protocols. This technique allows for the enforcement of more sophisticated policies, such as prioritizing certain applications or enforcing different security protocols depending on the identified traffic type. While effective for established applications, DPI systems struggle with newly introduced or unknown applications, particularly in dynamic environments such as cloud networks or containerized application ecosystems, where IP addresses and application configurations can change rapidly.

Another approach to application identification involves the use of application-layer gateways (ALGs) or proxies that sit between the client and server, inspecting and sometimes modifying traffic before it reaches its destination. These systems can provide an additional layer of control by enforcing policies based on application-layer information, such as authentication, content filtering, or data loss prevention. However, ALGs are often application-specific and require updates or configurations whenever a new application is introduced. This makes them less adaptable in environments where applications change frequently or where the network is highly dynamic.

Additionally, some conventional systems attempt to address the challenge of dynamic application identification by leveraging machine learning or heuristic techniques to classify traffic based on patterns or behaviors. These systems can learn from ongoing traffic flows and adapt their policies in response to new applications or traffic types. While this approach offers flexibility and scalability, it still requires a significant amount of training data and is not always precise in identifying applications, especially when dealing with encrypted or obfuscated traffic.

Overall, while existing systems provide various methods for identifying and enforcing policies on application traffic, they often lack the agility required to keep pace with the ever-changing landscape of modern network applications. Static methods like IP-based filtering and signature-based detection are not sufficient for handling the rapid growth and evolution of application environments, especially in dynamic and complex network architectures like cloud environments or large-scale enterprise networks. These limitations highlight the need for more adaptive and automated solutions that can dynamically identify and apply policies to traffic associated with a broad range of applications.

Various embodiments provide a solution to these challenges by introducing a dynamic system that maps network traffic to specific applications based on their association with a wildcard application group. In some embodiments, the system leverages a flexible IP address pool to dynamically assign and manage IP addresses for applications as they are discovered or added to the group. In some embodiments, the system leverages a general IP address pool to dynamically assign IP addresses from the general IP address pool for applications and associates the assigned IP address to the appropriate wildcard application group to which the application belongs as they are discovered or added to the group. This technique allows the system to automatically detect traffic associated with applications in the wildcard application group and apply the appropriate network traffic policies, including security protocols, without requiring manual intervention or static configurations. As a result, organizations can maintain up-to-date and accurate policy enforcement for all applications within the network, regardless of changes in the application landscape.

Furthermore, various embodiments provide a method for dynamic discovery of applications based on intercepted network traffic, such as DNS requests and responses. This dynamic discovery mechanism ensures that the system can continuously identify new applications and assign them IP addresses within (or otherwise to be associated with) the wildcard application group as needed. By automating the process of assigning and mapping IP addresses, the system can seamlessly integrate new applications into the existing network policy structure, ensuring that security and access rules are always enforced, even as the network evolves. The ability to apply these policies dynamically, based on real-time traffic analysis and the mapping of applications to wildcard application groups, represents a significant advancement in network traffic management.

Various embodiments provide a system, method, and device for managing network traffic policies, such as security protocols, by associating network traffic with an application group, specifically a wildcard application group. This technique dynamically applies policies to network traffic based on the identification of the traffic as belonging to a specific application within a wildcard application group (e.g., a predefined wildcard application group). The system determines that the traffic is associated with an application within a wildcard application group based at least in part on evaluating the IP address involved. If the IP address is mapped to the wildcard application group, the system can apply the appropriate network traffic policies, including security measures, for that group.

In some embodiments, the system configures an IP address pool associated with a particular wildcard application group. Each application within the wildcard application group is allocated an address from this pool, and if necessary, the IP address pool can be expanded to accommodate additional applications discovered within the group. The mapping of an IP address from the IP address pool to a specific application enables the system to detect and enforce policies on traffic associated with that application. The dynamic nature of the system ensures that new applications can be detected as they emerge, with their corresponding IP addresses assigned and mapped to the appropriate wildcard application group for subsequent policy enforcement.

In some embodiments, the system supports dynamic discovery of applications through the interception of network traffic, such as DNS requests. When a new application is detected, the system assigns it an IP address from the pool, maps that address to the wildcard application group, and subsequently updates the network to reflect the mapping. This technique enables the system to continue enforcing the necessary policies as new applications are discovered and integrated into the wildcard application group. When the system receives traffic directed at the assigned IP address, it can translate the address to the actual server address and process the traffic according to the relevant network policies, ensuring that security measures and other traffic rules are applied consistently and dynamically across the network.

Various embodiments provide a method, system, and computer system for causing network traffic handling policies to be enforced with respect to a network traffic sample. An example of the method includes (i) configuring a wildcard application group with a wildcard Fully Qualified Domain Name (FQDN) for a set of one or more applications, and (ii) allocating an internet protocol (IP) address from an address pool to an application matching the wildcard FQDN.

Various embodiments provide a method, system, and computer system for causing network traffic handling policies to be enforced with respect to a network traffic sample. An example of the method includes (a) configuring a wildcard application group with a wildcard FQDN for a set of one or more applications, (b) allocating an IP address from an IP address pool to a particular application matching the wildcard FQDN, (c) associating the allocated IP address with the wildcard application group; and (d) providing an indication that the allocated IP address is associated with the wildcard application group.

Various embodiments provide a method, system, and computer system for causing network traffic handling policies to be enforced with respect to a network traffic sample. An example of the method includes (a) obtaining a network traffic sample, (b) determining that the network traffic sample is for an application that belongs to a wildcard application group, and (c) handling the network traffic sample based at least in part on a determination that the network traffic sample is for an application that belongs to the wildcard application group.

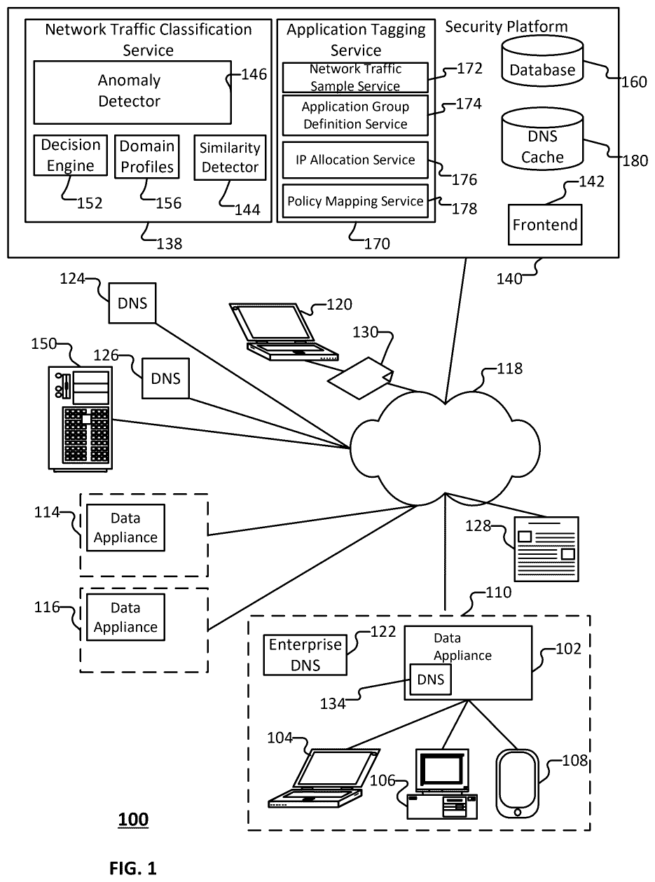

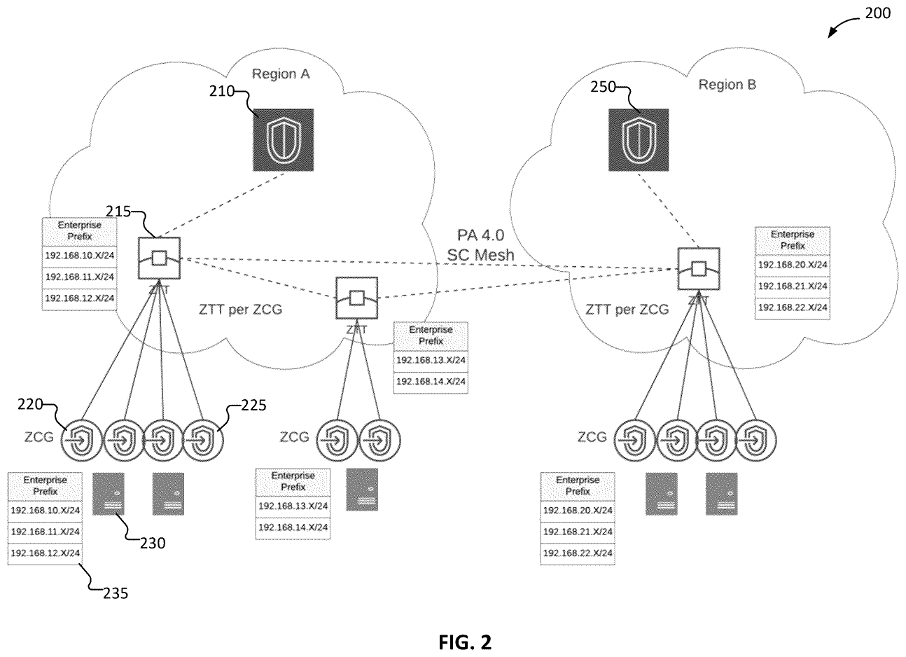

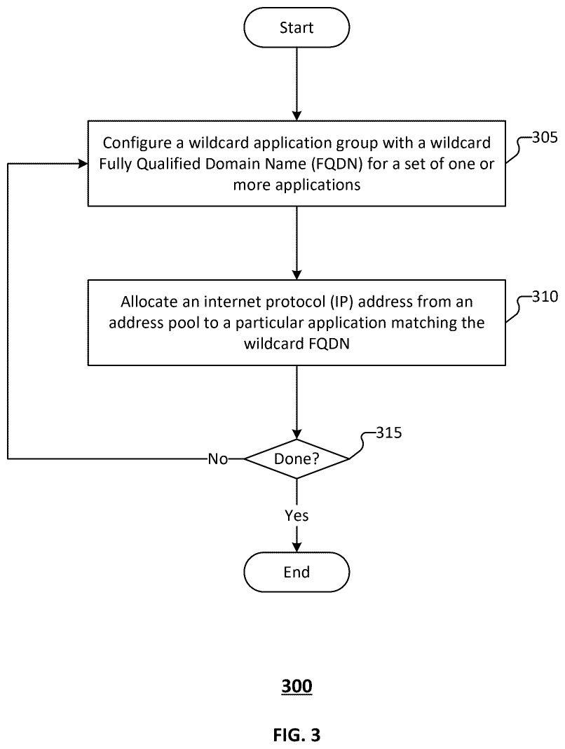

FIG. 1 is a block diagram of an environment for providing a security service to a network according to various embodiments. In some embodiments, system 100 implements at least part of system 200 of FIG. 2. In some embodiments, system 100 implements one or more of processes 300-600 of FIGS. 3-6.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively blocking or sinkholing traffic, such as traffic to malicious domains, DNS hijacked domains, stockpiled domains, or squatting domains, or such as traffic for certain applications (e.g., SaaS applications). In some embodiments, data appliance 102 is also configured to enforce policies with respect to traffic that stays within (or from coming into) enterprise network 110.

System 100 comprises a security platform 140 that can provide security services for enterprise networks, for example, by enforcing policies with respect to certain application network traffic. The system is configured to detect application traffic and determine an appropriate network traffic policy, for example, based at least in part on the IP address for the application traffic. The system can determine the appropriate network traffic policy based on determining a wildcard application group to which the application corresponding to the application network traffic belongs. In some embodiments, the system determines the wildcard application group to which the application corresponding to the application network traffic belongs based at least in part on obtaining the IP address for the application network traffic and determining the wildcard application group to which the IP address is mapped/associated.

In some embodiments, the system is configured to discover new applications and allocate/assign an IP address from an IP address pool. In some implementations, the IP address is allocated from a predefined IP address pool that is mapped to (e.g., associated with) a particular wildcard application group. In some implementations, the IP address is allocated from a general IP address pool and the system can thereafter map the allocated IP address to (e.g., associate with) a particular wildcard application group.

Techniques described herein can be used in conjunction with a variety of platforms (e.g., desktops, mobile devices, gaming platforms, embedded systems, etc.) and/or a variety of types of applications (e.g., Android . ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including one or more of (a) discovering new applications, tagging application network traffic for newly discovered applications in a manner that is indicative that the application network traffic is associated with a particular wildcard group, (b) intercepting application network traffic, (c) identifying a wildcard application group to which an application associated with application network traffic belongs (e.g., based on the IP address for the application network traffic), (d) determining a policy (e.g., a network traffic policy, such as a security policy) to be enforced for application network traffic (e.g., based on the associated wildcard application group), (e) handling the application network traffic, for example, based on enforcing the appropriate policy.

Security platform 140 can provide additional services, including authenticating endpoints, providing secure access to network resources, resolving DNS queries, providing DNS resolving security services, classifying domains (e.g., predicting whether a domain is a malicious domain, etc.), classifying DNS response records (e.g., predicting whether a domain IP pair in a DNS response is a DNS hijacked record, etc.), classifying network traffic, classifying DNS traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pDNS data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, detecting squatting domains, detecting a DNS cache poisoning attack (e.g., an attempt or a DNS cache entry stored based on an effective DNS cache poisoning attack), providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that DNS traffic (e.g., a domain or DNS record comprised in the DNS traffic) is malicious or benign, providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), etc.

In some embodiments, network security services, such as policy enforcement services, are implemented at data appliance 102. As an example, data appliance 102 can discover new applications (e.g., via resolved FQDN in corresponding DNS traffic). As another example, data appliance 102 can intercept application network traffic and apply appropriate policies based on a determination that the application network traffic is for an application belonging to a particular wildcard application group.

In some embodiments, network security services are implemented by one or more servers, such as a cloud service. Examples of the network security services include one or more of: (a) discovering new applications, tagging application network traffic for newly discovered applications in a manner that is indicative that the application network traffic is associated with a particular wildcard group, (b) intercepting application network traffic, (c) identifying a wildcard application group to which an application associated with application network traffic belongs (e.g., based on the IP address for the application network traffic), (d) determining a policy (e.g., a network traffic policy, such as a security policy) to be enforced for application network traffic (e.g., based on the associated wildcard application group), (e) handling the application network traffic, for example, based on enforcing the appropriate policy.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or application tagging service 170. Security platform 140 may include various other services/modules, such as a malicious file detector, a malicious traffic detector, a parked domain detector, an application classifier or other traffic classifier, etc.

Network traffic classification service 138 is used in connection with analyzing network traffic (e.g., websites, domains, sample files, etc. pertaining to the network traffic) and/or automatically detecting malicious network traffic.

Application tagging service 170 is used in connection with providing security services for a network, for example, in connection with securely handling application network traffic. Application tagging service 170 can be implemented to enforce a security policy for application network traffic. In some embodiments, application tagging service 170 performs an application detection and enforcement of policies with respect to corresponding application network traffic. Application tagging service 170 discovers new applications, allocates/assigns an IP address in a manner that the allocated IP address is tagged or associated with a wildcard application group, and causes network traffic for the applications to be handled securely (e.g., based at least in part on the IP address for the network traffic). In response to receiving network traffic, application tagging service 170 can determine the IP address (e.g., a source IP address or a destination IP address) for the network traffic, determine that the network traffic corresponds to a particular wildcard application group based at least in part on the IP address, and enforcing a network traffic policy (e.g., a security policy) based at least in part on a determination that the application associated with the network traffic belongs to wildcard application group.

In some embodiments, application tagging service 170 or a part thereof is implemented at a security entity, such as at data appliance 102. In other embodiments, the detection of application network traffic and appropriately handling the application network traffic (e.g., based on determining an IP address for the application and an enforcement of a security policy applicable to a wildcard application group).

In some embodiments, application tagging service 170 comprises one or more of network traffic sample service 172, application group definition service 174, IP allocation service 176, and/or policy mapping service 178.

Application tagging service 170 uses network traffic sample service 172 to obtain a network traffic sample. For example, network traffic sample service 172 can obtain the network traffic sample from an inline security entity (e.g., a firewall, a next generation firewall, a gateway service, etc.), for example, to perform a classification (e.g., to determine whether the network traffic is malicious/benign, determine a wildcard application group with which the network traffic is associated, etc.). In some embodiments, the network traffic sample a DNS traffic sample, for example, a DNS query and/or DNS response. In some embodiments, the network traffic sample comprises application traffic, such as traffic via which an endpoint request a service from an application (e.g., a Software as a Service (SaaS) application) or traffic via which the application provides a service to an endpoint.

In some embodiments, network traffic sample service 172 is used in connection with determining a policy to be enforced with respect to the network traffic sample (e.g., based on querying policy mapping service 178) and causing the policy to be enforced. For example, security platform 140 (e.g., network traffic sample service 172) can enforce a policy to be applied to the network traffic sample in response to determining that the network traffic is application traffic for an application belonging to a particular wildcard application group (e.g., a wildcard application group for which the policy definition indicates the policy is to be enforced).

Application tagging service 170 uses application group definition service 174 to configure a wildcard application group. For example, application group definition service 174 can receive a group definition from an administrator or another system. In some embodiments, application group definition service 174 manages a wildcard application group, such as by managing membership to the wildcard application group. As an illustrative example, managing membership to the wildcard application group may include creating and/or maintaining a mapping of applications to wildcard application groups. In some embodiments, group definition service 174 can provide (e.g., push) various wildcard application groups (e.g., the mapping of applications to wildcard application groups) to security entities, such as inline security entities (e.g., next generation firewalls) for inline enforcement of network traffic policies (e.g., a security policy).

Application tagging service 170 uses IP allocation service 176 to allocate IP address to applications, such as newly discovered applications. Additionally, IP allocation service 176 can manage IP address pools, such as to allocate additional IP addresses to an application pool as a demand for the IP addresses grows (e.g., as the set of available IP addresses that can be assigned to particular applications/application traffic decreases or becomes less than a threshold number of IP addresses).

In some embodiments, IP allocation service 176 allocates an IP address to an application from an IP address pool associated with a particular wildcard application group. For example, a set of IP addresses can be pre-assigned/allocated to the wildcard application group, such as before the IP addresses are respectively allocated to a particular application. In response to identifying new traffic for an application (e.g., in response to discovering a new application), such as based on DNS traffic information (e.g., the resolved FQDN), IP allocation service 176 determines the wildcard application group to which the application belongs, and assigns an IP address from the predefined set of IP addresses for the wildcard application group.

In some embodiments, IP allocation service 176 allocates an IP address to an application from a general IP address pool such as a pool generally available to the system for allocation to various types of traffic (e.g., various application traffic for various applications). In response to identifying new traffic for an application (e.g., in response to discovering a new application), such as based on DNS traffic information (e.g., the resolved FQDN), IP allocation service 176 allocates/assigns to the application an IP address from the general IP address pool. In response to allocates/assigns to the application an IP address from the general IP address pool, IP allocation service 176 associates the particular allocated IP address with a wildcard application group to which the application belongs.

IP allocation service 176 can determine that an application associated with the network traffic sample belongs to a particular wildcard application group based at least in part DNS traffic, such as based on DNS data or pDNS data. In some embodiments, application tagging service 170 (e.g., IP allocation service 176) determines an FQDN for which a DNS request (e.g., a DNS request/query associated with a particular application) is resolved and can determine whether the associated resolved FQDN matches a wildcard FQDN for a wildcard application group. In response to determining that the resolved FQDN matches a particular wildcard FQDN, IP allocation service 176 determines that the application for the network traffic sample (e.g., the application traffic associated with the resolved FQDN) belongs to the particular wildcard application group associated with (e.g., mapped to) the wildcard FQDN.

Application tagging service 170 uses policy mapping service 178 to map network traffic policies (e.g., security policies) to wildcard application groups. For example, the policy mapping service 178 can obtain a network traffic policy, evaluate the policy definition, and determine a wildcard application group(s) for which the policy is to be applied based on the policy definition. Application tagging service 170 can use the policy mapping service 178 to determine whether a policy is to be applied for network traffic for an application within a wildcard application group.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, or whether a DNS record is malicious), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, a website content, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process.

The classifier(s) may implement one or more machine learning models that may be trained according to a machine learning process. Examples of machine learning processes that can be implemented include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic (e.g., that the domain associated with the network traffic is a squatting domain), system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample, or a domain associated with the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains (e.g., domains classified as squatting domains) or having certain characteristics/profiles is to be blocked and network traffic associated with other domains (e.g., domains not deemed to be squatting domains or otherwise malicious) or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed domain for a particular network traffic sample, such as a DNS request or DNS response), security platform 140 (e.g., network traffic classification service 138) sends an indication that network activity (e.g., other network traffic samples) associated with the domain are associated with, or otherwise correspond to, the determined classification. Security platform 140 can provide an indication that network traffic matching the network traffic sample predicted to be malicious (e.g., network traffic matching a domain predicted to be a squatting domain) is to be handled as a malicious network traffic. For example, security platform 140 determines (e.g., computes) a signature or identifier for the network traffic/activity (e.g., a hash or other signature, or identifier for the corresponding network session or domain), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable. In some embodiments, application tagging service 170 is implemented at enterprise DNS server 122 rather than, or in addition to, being implemented at security platform 140.

As mentioned above, in order to connect to a legitimate domain (e.g., www. example. com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite. com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system for causing network traffic handling policies to be enforced with respect to a network traffic sample according to various embodiments. In some embodiments, system 200 implements at least part of system 100 of FIG. 1. In some embodiments, system 200 implements one or more of processes 300-600 of FIGS. 3-6.

According to various embodiments, the configuration of a network traffic policy for a wildcard application group begins with identifying the set of applications that fall under the wildcard application group, typically defined by a wildcard domain or address. A wildcard application group could be represented by an address like *.app.example.com, where the wildcard (*) allows the system to include any subdomain of app.example.com as part of the same group. This means that any application under this domain, regardless of its specific subdomain or deployment, is considered part of the wildcard application groups and will be subject to the same network traffic policies. This approach allows network administrators to apply unified rules across a diverse set of applications that all share a common domain, without needing to manually configure policies for each individual application.

Once the wildcard application group is defined by the domain pattern, the network traffic policy can be created to enforce specific security measures or controls across all the applications associated with that domain. For example, a security policy for this wildcard application group might specify that all traffic directed to any IP address associated with subdomains of *.app.example.com be inspected for potential security threats. As an example, this policy might include blocking traffic from untrusted sources, scanning for malware, or ensuring that sensitive data is encrypted in transit. The wildcard domain allows for a broad enforcement of these rules across all applications (e.g., all applications within the wildcard application group), ensuring that no matter how many applications fall under the app.example.com domain, they are all protected by the same security measures.

For instance, consider a situation where the organization has several applications hosted under different subdomains of app.example.com, such as sales.app.example.com, hr.app.example.com, and support.app.example.com. All of these applications serve different business functions but may be deemed (e.g., by an enterprise or the enterprise administrator) share similar security requirements. A network traffic policy for the wildcard application group *.app.example.com might enforce that all traffic to and from these applications must be encrypted using HTTPS, restrict access to specific internal resources (such as database servers), and/or ensure that traffic from unrecognized IP addresses is blocked. By applying the policy to the entire wildcard domain, administrators ensure consistent security measures are implemented across all applications within the group, without needing to manually configure each application individually.

According to various embodiments, the dynamic nature of the wildcard application groups ensures that as new applications are introduced (e.g., onboarded, deployed, etc.) under the *.app.example.com domain, they will automatically inherit the same network traffic policy (e.g., the system will automatically discover the application and tag the application with the applicable wildcard application group). For example, if a new subdomain like marketing.app.example.com is created for a new application, it will automatically be included in the *.app.example.com wildcard application groups. This allows the same security policy to be applied seamlessly to the new application without requiring additional configuration steps. The network management system would recognize the new subdomain as part of the wildcard application groups and enforce the same policies for it, such as inspecting traffic for malicious content or ensuring secure communication channels.

The system can leverage the wildcard nature of the domain to enable efficient traffic detection and policy enforcement. According to various embodiments, the system can use DNS resolution to detect that a request to a specific subdomain, such as sales.app.example.com, is part of the wildcard application groups. In some embodiments, once this is identified, the system can apply the relevant security policies, such as routing the traffic through a secure firewall, performing deep packet inspection, or logging the traffic for auditing purposes. In other embodiments, once this is identified, the system can assign to this application traffic (e.g., to this address/domain) an IP address from an IP address pool (e.g., either a wildcard application group-specific IP address pool or a general IP address pool) in a manner that the assigned IP address is associated with the wildcard application group. In the case that the system assigns an IP address from a wildcard application group-specific IP address pool, the IP address is already associated with a wildcard application group (e.g., because the IP address pool is associated with the specific wildcard application group). In the case that the system assigns an IP address from a general IP address pool, the system can tag the assigned IP address with the wildcard application group, such by updating a mapping of IP addresses to wildcard application groups. By automatically tagging or mapping the traffic to the wildcard application groups, network devices such as firewalls, intrusion prevention systems, and load balancers can ensure that all traffic associated with the *.app.example.com group is properly handled according to the defined policies.

This technique for automatically discovering applications and associating applications with wildcard application groups in connection with network traffic policy enforcement for application traffic simplifies the management of security measures in environments where numerous applications fall under a common domain. It reduces the need for complex, application-specific configurations and ensures that new applications are automatically protected as they are added to the network, maintaining a consistent level of security across a broad and dynamic set of applications.

In the example shown, system 200 comprises gateway 210 and gateway 250, which can be respectively be disposed at different regions (e.g., region A and region B). A client can connect to a network via gateway 210 or gateway 250 and access network resources, such as applications. For example, a client can connect to gateway 210 to access an application (e.g., a SaaS application) that is provided by server 230.

In response to obtaining network traffic for the application (e.g., directed to server 230), the system (e.g., gateway 210 or a central controller/service such as security platform 140 of FIG. 1) can automatically discover new applications, such as based on DNS traffic for the application. In some embodiments, the system determines a resolved FQDN for the network traffic. The system determines whether the network traffic is for an application belonging to a wildcard application group. For example, the system can perform a matching between the resolved FQDN of the intercepted DNS traffic and the wildcard FQDN for any wildcard application groups. In response to determining that the FQDN matches the wildcard FQDN for a particular wildcard application group, the system (e.g., the gateway 210 or the central controller/service) determines that the application belongs to the wildcard application group.

In response to discovering the new application (e.g., determining that the application belongs to the wildcard application group), the system (e.g., the gateway 210 or the central controller/service) allocates an IP address to the new application. For example, the system can provide the IP address as the address for the application in a DNS response to an endpoint requesting to access the application. The system (e.g., gateway 210 or client connector such as client connector 220, client connector, 225, etc.) can perform an address translation upon receiving incoming application traffic destined to the application by translating it from the assigned IP address to the actual address of the appropriate server (e.g., application server 230). For example, the system can store a table 235 or other mapping of system-assigned IP addresses to actual IP addresses for applications, and the system (e.g., the client connector) can perform a lookup to determine the IP address for the application server to which the application traffic is to be routed.

In connection with assigning/allocating an IP address to the application, the system associates the assigned/allocated IP address to the wildcard application group to which the application belongs. In some embodiments, the system (e.g., gateway 210 or the central controller/service) assigns an IP address from an IP address pool that is pre-mapped to the wildcard application group, and thus the assignment of the IP address selected from the wildcard application group-specific IP address pool automatically associates the application with the wildcard application group. In some embodiments, the system (e.g., gateway 210 or the central controller/service) assigns an IP address from a general IP address pool (e.g., an IP address pool that is not mapped to any specific wildcard application group). The system then associates the allocated IP address to the particular wildcard application group to which the application belongs. For example, the system updates a mapping of IP addresses to wildcard application groups. As another example, the system stores a tag or other indication that the IP address is assigned to an application belonging to a particular wildcard application group.

In implementations in which a central controller/service or other service within the system detects new applications and assigns IP addresses for the applications, the central controller/service or other service provides to the system gateways (e.g., gateway 210, gateway 250, etc.) or other security entities a mapping of IP addresses to wildcard application groups. For example, the system pushes to gateway 210 an indication that a particular IP address is mapped to a particular wildcard application group. The gateway 210 can use this mapping to properly enforce network traffic policies that are defined to apply to specific wildcard application group(s).

FIG. 3 is a flow diagram of a method for allocating an internet protocol (IP) address from an address pool for an application group according to various embodiments. According to various embodiments, process 300 is implemented at least in part by one or more of system 100 of FIG. 1 and/or system 200 of FIG. 2. In some embodiments, process 300 is implemented by a firewall or gateway, such as application tagging service 170 of system 100.

In some embodiments, process 300 is implemented by a cloud service (e.g., one or more servers) that provides other network security services to various network endpoints or security entities. For example, the system may implement process 300 to allocate IP addresses to application traffic. The system can implement process 300 in connection with tagging application traffic to indicate that the application traffic belongs to a wildcard application group.

In some embodiments, the system defines an IP address pool for a particular wildcard application group as a range of IP addresses that are designated for use by any application associated with that group. The IP address pool is configured to ensure that there are enough addresses to accommodate the expected number of applications within the wildcard application groups, as well as any potential future additions. For example, if the wildcard application group is associated with a domain like *.app.example.com, the system would configure an address pool specifically for applications under that domain. The pool could include a broad range of IP addresses, such as those within a particular subnet or a series of individual addresses, depending on the scale and needs of the network.

Once the IP address pool is defined, the system can dynamically allocate IP addresses to new applications as they are discovered. This allocation process begins when the system detects network traffic that is associated with a new application, typically through methods like DNS request interception or traffic analysis. Upon identifying the application, the system first checks whether the application should be mapped to the wildcard application group based on the domain name or other identifying characteristics. If the application is indeed part of the wildcard application group, the system then selects an available IP address from the predefined IP address pool and assigns it to the new application.

The system's allocation of an IP address from the pool can be configured to be automated and seamless, ensuring that the new application is immediately ready to be integrated into the network traffic policy enforcement structure. The assigned IP address is then mapped to the wildcard application group, which effectively links it to the group's associated policies. This mapping allows network traffic directed to the newly assigned IP address to be subject to the same policies as other applications within the wildcard application groups. For example, the policies might include security measures like access controls, traffic inspection, or encryption requirements.

Upon the IP address being assigned to an application (e.g., to application traffic) and mapped to a wildcard application group(s), any subsequent traffic directed to that address will be processed according to the policies defined for the wildcard application groups. Network appliances (e.g., security entities) such as firewalls, load balancers, and intrusion detection systems can recognize the newly assigned IP address (e.g., detect the IP address in intercepted application traffic) and automatically apply the necessary policies without requiring any manual configuration (e.g., to associate the application with the wildcard application group). This can ensure that all applications within the wildcard application groups, whether newly discovered or previously configured, are treated consistently and securely across the network.

In some embodiments, the system is configured to enable the dynamic expansion of the IP address pool when necessary. If the IP address pool (e.g., the IP address pool mapped to a particular wildcard application group(s)) becomes fully allocated due to the addition of new applications, the system can extend the IP address pool by adding more IP addresses, ensuring that new applications can still be accommodated. This flexibility enables the system to maintain scalability of the network and ensuring that policies can be enforced consistently across an expanding set of applications. By automating the assignment of IP addresses and their association with the wildcard application group, the system simplifies the management of network traffic and ensures that security policies are dynamically applied to all applications as they are discovered and integrated into the network environment.

At 305, the system configures a wildcard application group with a wildcard FQDN for at least a set of one or more applications. At 310, the system allocates an IP address from an address pool to a particular application matching the FQDN. At 315, the system determines whether process 300 is complete. In some embodiments, the system determines process 300 to be complete in response to a determination that no further application traffic is to be tagged or otherwise associated with a wildcard application group, no further network traffic is received, an administrator indicates that process 300 is to be paused or stopped, etc. In response to a determination that process 300 is complete, process 300 ends. In response to a determination that process 300 is not complete, process 300 returns to 305.

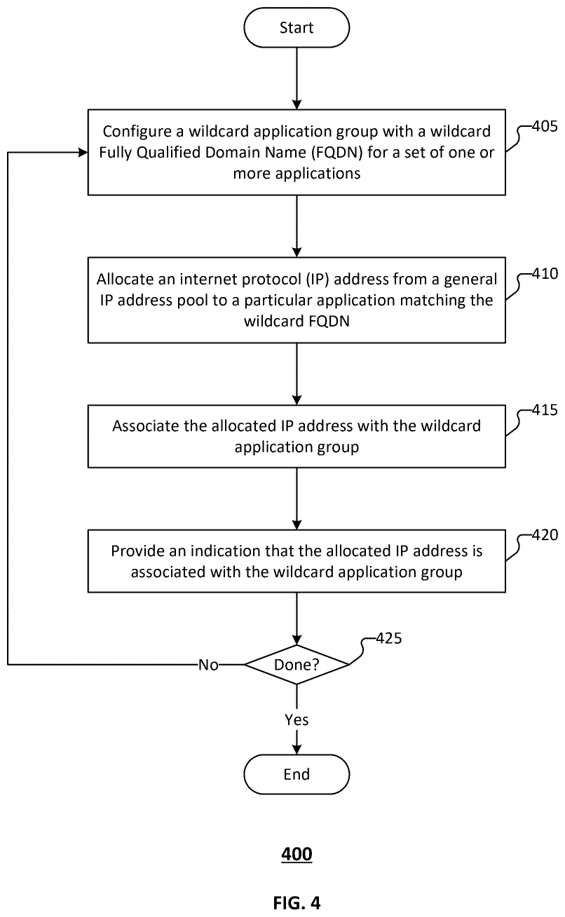

FIG. 4 is a flow diagram of a method for allocating an internet protocol (IP) address from an address pool for an application group according to various embodiments. According to various embodiments, process 400 is implemented at least in part by one or more of system 100 of FIG. 1 and/or system 200 of FIG. 2. In some embodiments, process 400 is implemented by a firewall or gateway, such as application tagging service 170 of system 100.

In some embodiments, process 400 is implemented by a cloud service (e.g., one or more servers) that provides other network security services to various network endpoints or security entities. For example, the system may implement process 400 to allocate IP addresses to application traffic. The system can implement process 400 in connection with tagging application traffic to indicate that the application traffic belongs to a wildcard application group.

In some embodiments, the system selects an IP address from a general IP address pool, which consists of a range of addresses that can be used for various applications across different application groups. This IP address pool is not limited to a specific set of applications, allowing for flexibility in assigning IP addresses to new applications as they are discovered. The system does not initially associate the IP address with any particular application group but assigns it to an application based on the domain or other identifying features of the application once it has been detected in the network.

Once an application is detected, for example, through traffic analysis or DNS resolution, the system assigns one of the available IP addresses from the general IP address pool to the newly discovered application. At this point, the system performs an additional step of tagging or otherwise associating the assigned IP address with a specific wildcard application group, such as *.app.example.com. This step is crucial because it establishes a link between the IP address and the wildcard application group, effectively binding the network traffic to the policies set for that wildcard application group. The tagging process could involve marking the IP address in the system's database, updating network management systems, or configuring network devices to recognize the IP address as belonging to the wildcard application group.

The association of the IP address with the wildcard application group enables the system to detect network traffic as belonging to that specific group. When network traffic is directed to the assigned IP address, the system can immediately identify that the traffic is associated with the wildcard application group. This is achieved by referencing the tag or association stored in the system, which tells the system that any traffic directed to this particular IP address should be treated according to the policies of the wildcard application group. This tagging mechanism ensures that traffic is properly classified, regardless of the specific application generating the traffic.

For example, if the wildcard application group is associated with all subdomains under *.app.example.com, the system knows that any traffic coming to the assigned IP address for an application under this domain is part of the group. The system can then apply relevant network traffic policies, such as security protocols, filtering rules, or access controls, based on the mapping of the IP address to the wildcard application group. These policies could include inspecting the traffic for security threats, encrypting sensitive data, or ensuring that access is restricted based on predefined criteria, such as user authentication or IP address ranges.

By tagging the IP address and associating it with the wildcard application group, the system ensures that security and network management policies are dynamically enforced as the network environment evolves. This approach simplifies the management of diverse applications, as network traffic for all applications within the wildcard application group is handled uniformly, regardless of the specific underlying application or infrastructure changes. This capability to dynamically detect and classify traffic based on assigned IP addresses is a critical feature for managing network policies in modern, dynamic network environments.

At 405, the system configures a wildcard application group with a wildcard FQDN for at least a set of one or more applications. At 410, the system allocates an IP address from a general IP address pool to a particular application matching the wildcard FQDN (e.g., *.app.example.com). At 415, the system associates the allocated IP address with the wildcard application group. At 420, the system provides an indication that the allocated IP address is associated with the wildcard application group. At 425, the system determines whether process 400 is complete. In some embodiments, the system determines process 400 to be complete in response to a determination that no further application traffic is to be tagged or otherwise associated with a wildcard application group, no further network traffic is received, an administrator indicates that process 400 is to be paused or stopped, etc. In response to a determination that process 400 is complete, process 400 ends. In response to a determination that process 400 is not complete, process 400 returns to 405.

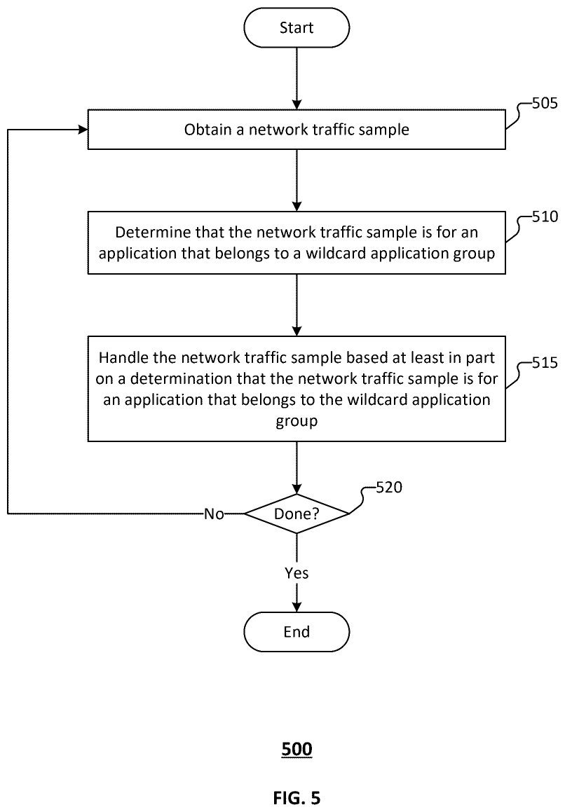

FIG. 5 is a flow diagram of a method for handling network traffic sample for an application within a particular application group according to various embodiments. According to various embodiments, process 500 is implemented at least in part by one or more of system 100 of FIG. 1 and/or system 200 of FIG. 2. In some embodiments, process 500 is implemented by a firewall or gateway, such as application tagging service 170 of system 100.

In some embodiments, process 500 is implemented by a cloud service (e.g., one or more servers) that provides other network security services to various network endpoints or security entities. For example, the system may implement process 500 to handle application traffic. The system can implement process 500 in connection with handling application traffic according to a wildcard application group to which the application belongs.

One common example of a network traffic policy is a security policy designed to protect the network from malicious activities and unauthorized access. A security policy typically focuses on controlling access to network resources, monitoring traffic for suspicious behavior, and mitigating potential threats. For instance, a security policy might dictate that traffic from untrusted sources or IP addresses is blocked or subjected to additional scrutiny, such as deep packet inspection or encryption. Policies may also specify which types of traffic are allowed to access specific services or resources, such as permitting only authorized users to access internal databases or restricting access to certain web applications based on the user's role or IP address.

Another example of a network traffic policy could be a Quality of Service (QoS) policy, which manages the priority of different types of traffic to ensure that critical applications or services receive the necessary network bandwidth. For example, in a business environment, a QoS policy may prioritize VoIP (Voice over Internet Protocol) traffic to ensure high-quality voice communication, while deprioritizing less time-sensitive traffic such as file downloads or bulk email transmissions. This type of policy helps to optimize network performance by ensuring that important traffic flows smoothly, even when the network is under heavy load.

In addition to these policies, a security policy that enforces traffic inspection and filtering might involve monitoring network traffic for signs of malware or other malicious activity. For instance, an Intrusion Prevention System (IPS) or firewall might inspect incoming and outgoing traffic for known signatures of viruses, ransomware, or other types of malware. If suspicious traffic is detected, the system could block it in real-time or alert the network administrator. Another security policy might involve enforcing encryption for sensitive traffic, ensuring that all data transmitted over the network is encrypted to prevent eavesdropping or man-in-the-middle attacks. Similarly, a network access control policy might restrict certain users or devices from accessing specific segments of the network based on security protocols or authentication methods.

In some embodiments, a policy is defined to be applicable to a wildcard application group, which can be a collection of predefined IP addresses (e.g., corresponding to a set of predefined applications that belong to the wildcard group). An example, A policy address object with the wildcard label/tag can be created by the user and consumed as the destination in one or more descriptive policies which may include multiple matching criteria. Every time the IP address pool for the wildcard application group is updated, the control plane is sent a message with the label and the Address Pool entries. An example of a policy definition applicable to a particular wildcard application group (e.g., wildcard label=WildcardWebappExampleLocal, etc.) is: {from UserGroup A to Destination AO-WildcardWebapp ExampleLocal Port 22 Deny; from UserGroup B to Destination AO-WildcardExampleLocal Port 22 Allow}. An example of a policy definition applicable to a particular wildcard application group based on a wildcard application group-specific IP address pool is {wildcard label=WildcardWebappExampleLocal, etc.) is: {from UserGroup A to Destination {100.64.10.32/27} Port 22 Deny; from UserGroup B to Destination {100.64.10.0*27} Allow}.

Overall, network traffic policies are vital for ensuring both the security and efficiency of network operations. By enforcing appropriate rules and guidelines, organizations can control how data flows through their networks, protect against security threats, and ensure that critical applications receive the necessary resources.

According to various embodiments, the system enforces a network traffic policy by intercepting network traffic as it traverses through the network infrastructure. This interception occurs at key points in the network, such as gateways, firewalls, or routers, where the system is positioned to capture and analyze traffic before it reaches its destination. By intercepting traffic, the system can examine the data packets, identify their source and destination, and evaluate the type of communication taking place. This interception and examination of network traffic (e.g., application traffic) enables the system to ensure that network traffic is aligned with the security and management policies defined for the network.

Once the traffic is intercepted, the system applies various filtering mechanisms to determine whether the traffic matches the criteria defined by the network traffic policy. For example, the system can analyze the packet headers to identify the source and destination IP addresses, ports, or protocol types. The system can obtain the IP address (e.g., the destination IP address for incoming traffic via which an endpoint is communicating with an application server) and determine whether the IP address corresponds to an application in a wildcard application group. If the IP address is mapped to a wildcard application group, the system determines the wildcard application group to which the network traffic corresponds and the system identifies one or more policies to be applied with respect to the wildcard application group. The policies for this wildcard application group may include security measures, such as blocking traffic from untrusted sources, enforcing encryption, or inspecting the payload for malicious content. If the intercepted traffic aligns with the wildcard application group's policy, the system will allow it to pass through or apply the appropriate actions, such as forwarding it to the correct application server or initiating further inspection.

In some embodiments, the enforcement of these policies is dynamic, meaning that the system continuously evaluates and reacts to intercepted traffic in real-time. When new applications are introduced to the network, or when traffic patterns change, the system can dynamically adjust its enforcement actions based on the updated policies. The dynamic enforcement can be used to ensure that no traffic, regardless of when the application is discovered, is allowed to bypass the established security and traffic management rules.

In practice, the system may employ a combination of techniques to enforce the network traffic policy. This could involve intrusion detection systems (IDS) to flag suspicious activity, deep packet inspection (DPI) to analyze the contents of the traffic for signs of malicious behavior, or Quality of Service (QoS) rules to prioritize critical traffic. For example, if traffic from a new application under the wildcard application group is deemed potentially harmful, the system could block it or alert the network administrator. If the traffic is legitimate, it could be routed to its destination after applying any necessary filtering or encryption.

At 505, the system obtains a network traffic sample. At 510, the system determines that the network traffic sample is for an application that belongs to a wildcard application group. At 515, the system handles the network traffic sample based at least in part on a determination that the network traffic sample is for an application that belongs to the wildcard application group. At 520, the system determines whether process 500 is complete. In some embodiments, the system determines process 500 to be complete in response to a determination that no further network traffic policies (e.g., security policies) are to be enforced, no further network traffic is received, an administrator indicates that process 500 is to be paused or stopped, etc. In response to a determination that process 500 is complete, process 500 ends. In response to a determination that process 500 is not complete, process 500 returns to 505.

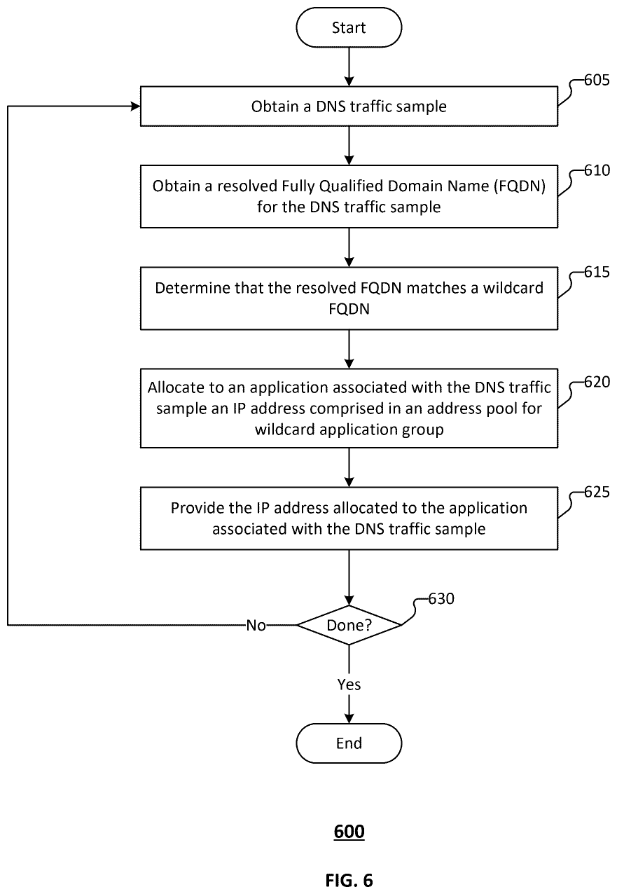

FIG. 6 is a flow diagram of a method for allocating an IP address to a discovered application according to various embodiments. According to various embodiments, process 600 is implemented at least in part by one or more of system 100 of FIG. 1 and/or system 200 of FIG. 2. In some embodiments, process 600 is implemented by a firewall or gateway, such as application tagging service 170 of system 100.

In some embodiments, process 600 is implemented by a cloud service (e.g., one or more servers) that provides other network security services to various network endpoints or security entities. For example, the system may implement process 600 to allocate IP addresses to application traffic. The system can implement process 600 in connection with tagging application traffic to indicate that the application traffic belongs to a wildcard application group.

The system discovers new applications through dynamic analysis of network traffic, particularly by intercepting requests and monitoring the behaviors of traffic flows within the network. According to various embodiments, the system discovers applications by observing DNS requests, where the system can capture domain name resolution queries made by client systems. When an application generates a DNS request for a particular domain, such as a request to access a service hosted under *.app.example.com, the system can inspect the DNS response to determine the associated IP address. By resolving the domain, the system learns that traffic directed to the resolved IP address is related to a new application that needs to be incorporated into the existing wildcard application group.

Once the system identifies new traffic for an application, it begins the process of assigning an IP address from a predefined IP address pool that is associated with the wildcard application group. For example, if the wildcard application group is defined as *.app.example.com, the system could maintain an IP address pool of IP addresses that have been designated specifically for applications within that domain. When a new application is detected, whether through DNS resolution or another discovery method, the system assigns it an available IP address from the IP address pool. Because IP address is tagged or mapped (e.g., pre-tagged or pre-mapped) to the wildcard application group, the IP address is linked directly to the wildcard application group's policy enforcement framework.

By assigning an application a newly assigned IP address that is mapped to (e.g., associated with) the wildcard application group, the system ensures that any subsequent network traffic directed to this address will be treated according to the predefined network traffic policies for the wildcard application group. For instance, if the wildcard application group enforces certain security protocols, such as traffic encryption or access restrictions, these rules will automatically apply to any traffic destined for the newly assigned IP address. This ensures that the security policies are consistently enforced, regardless of when the new application was introduced into the network.

To manage this process efficiently, the system can be integrated with (or implemented at) network devices such as DNS servers, firewalls, and load balancers, which can recognize the newly assigned IP address and apply the correct policies to the traffic. When a client system attempts to communicate with the new application, it will use the assigned IP address. Upon detecting traffic directed at this address, security entities such as firewalls or intrusion prevention systems can recognize the mapping to the wildcard application group and enforce the relevant policies. These policies could include security measures such as packet inspection, malware scanning, or access control based on IP address or application-specific behavior.

This method of application discovery and IP address assignment is particularly valuable in dynamic environments where new applications are frequently introduced, and manual configuration of policies for each application would be inefficient and error-prone. The system's ability to automatically discover new applications and assign them to the appropriate wildcard application group ensures that network traffic policies are always up-to-date and consistent, providing ongoing protection and optimal network performance as the application landscape evolves.

At 605, the system obtains a DNS traffic sample. At 610, the system obtains a resolved FQDN for the DNS traffic sample. At 615, the system determines that the resolved FQDN matches a wildcard FQDN. At 620, the system allocates an application associated with the DNS traffic sample an IP address comprised in an address pool for wildcard application group. At 625, the system provides the IP address to the application associated with the DNS traffic sample. At 630, the system determines whether process 600 is complete. In some embodiments, the system determines process 600 to be complete in response to a determination that no further application traffic is to be tagged or otherwise associated with a wildcard application group, no further network traffic is received, an administrator indicates that process 600 is to be paused or stopped, etc. In response to a determination that process 600 is complete, process 600 ends. In response to a determination that process 600 is not complete, process 600 returns to 605.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
configure a wildcard application group with a wildcard Fully Qualified Domain Name (FQDN) for a set of one or more applications; and
allocate an internet protocol (IP) address from an address pool to a particular application matching the wildcard FQDN; and
a memory coupled to the one or more processors and configured to provide the one or more processors with instructions.

2. The system of claim 1, wherein the one or more processors are further configured to:
obtain a security policy, wherein a security policy definition indicates that the security policy is to be applied with respect to network traffic for the wildcard application group.

3. The system of claim 2, wherein the security policy is defined for a tenant of a cloud security service.

4. The system of claim 1, wherein a security policy for network traffic to the wildcard application group is enforced for the particular application based at least in part on a determination that the IP address for the particular application is comprised in the address pool.

5. The system of claim 1, wherein the one or more processors are further configured to:
map incoming network traffic with the wildcard application group based at least in part on a determination that the incoming network traffic is for the IP address allocated from the address pool.

6. The system of claim 1, wherein the one or more processors are further configured to:
dynamically discover a new application belonging to the wildcard application group.

7. The system of claim 6, wherein dynamically discovering the new application belonging to the wildcard application group comprises:
obtaining a DNS record for network traffic associated with the new application; and
determining that a server address for the new application matches the wildcard FQDN for the wildcard application group.

8. The system of claim 6, wherein the one or more processors are further configured to:
in response to discovering a new application belonging to the wildcard application group, allocate for the new application a particular IP address selected from the address pool for the wildcard application group.

9. The system of claim 6, wherein the new application is dynamically discovered based at least in part on a determination that DNS traffic for the new application.

10. The system of claim 6, wherein the new application is dynamically discovered based at least in part on a determination that DNS traffic comprises a resolved FQDN that matches the wildcard FQDN.

11. The system of claim 1, wherein the one or more processors are further configured to:
in response to discovering new applications belonging to the wildcard application group, allocating additional IP addresses to the address pool.

12. The system of claim 1, wherein the address pool comprises a predetermined IP address range.

13. The system of claim 1, wherein the one or more processors are further configured to:
intercept network traffic;
determine that the network traffic is for a particular IP address comprised in the address pool;
in response to determining that the network traffic is for the particular IP address comprised in the address pool, determine a policy to be enforced for the wildcard application group; and
handle the network traffic based at least in part on enforcing the policy.

14. A system, comprising:
one or more processors configured to:
configure a wildcard application group with a wildcard Fully Qualified Domain Name (FQDN) for a set of one or more applications;
allocate an internet protocol (IP) address from a general IP address pool to a particular application matching the wildcard FQDN; and
associate the allocated IP address with the wildcard application group; and
provide an indication that the allocated IP address is associated with the wildcard application group;
a memory coupled to the one or more processors and configured to provide the one or more processors with instructions.

15. The system of claim 14, wherein the one or more processors are further configured to:
intercept incoming traffic;
determine a destination for the incoming traffic;
determine that the destination for the incoming traffic matches an address associated with the wildcard application group;
handle the incoming traffic based at least in part on a determination of the wildcard application group matching the destination.

16. A system, comprising:
one or more processors configured to:
obtain a network traffic sample;
determine that the network traffic sample is for an application that belongs to a wildcard application group;
handle the network traffic sample based at least in part on a determination that the network traffic sample is for an application that belongs to the wildcard application group; and
a memory coupled to the one or more processors and configured to provide the one or more processors with instructions.

17. The system of claim 16, wherein handling the network traffic sample based at least in part on a determination that the network traffic sample is for an application that belongs to the wildcard application group comprises:
enforcing a network traffic policy applicable for the wildcard application group.

18. A method, comprising:
configuring a wildcard application group with a wildcard Fully Qualified Domain Name (FQDN) for a set of one or more applications; and
allocating an internet protocol (IP) address from an address pool to a particular application matching the wildcard FQDN.

19. A computer program product embodied in a non-transitory computer readable medium and comprising computer instructions for:
configuring a wildcard application group with a wildcard Fully Qualified Domain Name (FQDN) for a set of one or more applications; and
allocating an internet protocol (IP) address from an address pool to a particular application matching the wildcard FQDN.

20. A method, comprising:
configuring a wildcard application group with a wildcard Fully Qualified Domain Name (FQDN) for a set of one or more applications;
allocating an internet protocol (IP) address from a general IP address pool to a particular application matching the wildcard FQDN;
associating the allocated IP address with the wildcard application group; and
providing an indication that the allocated IP address is associated with the wildcard application group.

21. A method, comprising:
obtaining a network traffic sample;
determining that the network traffic sample is for an application that belongs to a wildcard application group; and
handling the network traffic sample based at least in part on a determination that the network traffic sample is for an application that belongs to the wildcard application group.
